(19) United States
(12) Patent Application Publication
(10) Pub. No.: US 2006/0126478 A1
(43) Pub. Date: Jun. 15, 2006

(54) Optical disc drive apparatus

(75) Inventor: Gheorghe Sorin Stan, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., 5621 BA EINDHOVEN (NL)

(21) Appl. No.: 10/559,355

(22) PCT Filed: May 28, 2004
(86) PCT No.: PCT/IB04/50808

§ 371 Date: Dec. 6, 2005

(30) Foreign Application Priority Data
Jun. 11, 2003 (EP) 03101697.5

(51) Int. Cl. G11B 5/09

(52) U.S. Cl. 369/124.01; 369/47.1

(57) ABSTRACT

In an optical disc drive apparatus (1) capable of writing information to a recordable optical disc (2), a control circuit (10) for controlling an optical pickup unit (5) comprises: a controllable DC controller (22) adapted to give a DC offset to an analog data signal (RF); a variable gain amplifier (23) for amplifying the DC-shifted analog data signal (RF_{S}); an AD-converter (24) for receiving the amplified analog signal (RF_{A}); a digital calculating block (25) for receiving the digital output Signal (RF_{D}) 10 from the AD-converter (24) and digitally calculating at least one parameter (β, m) indicative of write operation quality; a processor (26) for receiving said at least one quality indicating parameter (β, m) and calculating a suitable power setting for the laser source of the optical pickup (5) on the basis of said at least one quality indicating parameter (β, m).

The present invention relates in general to the art of data storage devices, such as optical disc devices. More particularly, the present invention relates to a disc drive apparatus for writing/reading information into/from an optical disc; hereinafter, such a disc drive apparatus will also be indicated as “optical disc drive”. Examples of optical discs include CD discs, DVD discs, and the like.

As is commonly known, an optical storage disc comprises at least one track, either in the form of a continuous spiral or in the form of multiple concentric circles, of storage space where information may be stored in the form of a data pattern. Optical discs may be of the read-only type, on which the information is recorded during manufacturing and can subsequently be read by the user. The optical storage disc may also be of a writeable type, on which the information can be stored by the user. The present invention relates specifically to a disc drive capable of writing information onto an optical disc of a writeable type, such as CD-R/RW, DVD-R/RW, DVD+R/RW, DVD-RAM, BD-RE, and BD-R For writing information into the storage space of the optical disc, an optical disc drive comprises optical means for generating an optical beam, typically a laser beam, and for scanning the storage track with said optical beam. Since the technology of optical discs in general, the way in which information can be stored on an optical disc, and the way in which optical data can be read from an optical disc are widely known, it is not necessary to describe these techniques in more detail here.

For correctly writing a data pattern into a storage layer of an optical disc, the power of the laser source should have a suitable value set in relation to the characteristics of the optical disc being written. Therefore, it is known to perform a calibration procedure before the actual writing operation. During this calibration procedure (known as an Optimum Power Calibration procedure), the optical power of the laser source is calibrated by setting the laser power to an initial test setting and writing a test pattern in a portion of the storage space that is specifically reserved for the purpose of calibration; this portion will also be indicated as calibration test area After writing of the test pattern, the written data sequence is read back from the disc and a check is made as to whether the writing performance has been adequate. From the optical signal obtained during this readout, an optimum power setting is calculated. This calibration procedure is repeated if so desired, the laser source now being set at the calculated optimum power setting, and a new optimum power setting is again calculated. It may be that this second calibration procedure obtains a refinement of the optimum power setting. Usually a third calibration procedure is not expected to give a significant improvement

The optimum power is calculated from two parameters that are derived from a set of signals obtained during the readout, these two parameters being commonly designated as β (BETA) and m (MODULATION). These parameters are known in the prior art, as are several formulas for calculating the optimum power P_{OPT} from these two parameters. The calibration of the laser power is, however, not limited to the use of the parameters β and m, and other parameters of the readout signals may alternatively be used. The set of readout signals is obtained in that test patterns are recorded with different settings of the laser powers during recording.

The electrical output signal obtained during read-back from the optical detector is in general an analog signal, whereas the calculation of the optimum power P_{OPT} is done more conveniently in the digital domain. Therefore, a control circuit of an optical disc drive for performing optimum power calibration needs, in general, to have analog-to-digital converter means. In the prior art, said two parameters β and m are derived from the RF optical signal in the analog domain, after which the RF signal, β and m are converted to the digital domain for further processing by a digital controller. Since the accuracy of all subsequent recordings depends on the initial calibration of the laser power, determining the RF signal parameters correctly is an important condition for the correct operation of the optical drive. This requires an adequate precision of the analog-to-digital conversion and a correct handling of the various disturbances in the system, such as DC offsets and the like. In addition, the laser power may be re-adjusted in real time during normal operation, for which operation the accuracy of the AD converters is equally important In some situations, a trade-off may be required between the number of quantization levels (for example 6-versus 8-bit AD conversion) and the operational speed of the AD converter. Yet, in other cases it may be desirable to reduce the number of quantization bits since this leads to less silicon surface area and subsequently to cheaper integrated circuits.

It is an objective of the present invention to provide a disc drive apparatus with an improved control circuit This object is achieved according to the present invention in that an optical disc drive apparatus as claimed in claim 1 is provided.

According to an aspect of the present invention, the control circuit in the optical disc drive apparatus comprises an analog section which comprises DC offset means and controllable gain means for suitably scaling the RF optical signal which is received by AD converting means for conversion to the digital domain. The control circuit further comprises digital parameter calculating means for calculating recording parameters, such as said parameters β and m, from the digital optical signal. Due to the scaling of the RF readout signal, a sufficient measurement accuracy of the RF parameters can be achieved with an AD converter having 6-bit resolution, which operates substantially faster than an 8-bit AD converter. Furthermore, a substantial saving is achieved in chip surface area.

These and other aspects, features, and advantages of the present invention will be further explained by the following description of the present invention with reference to the drawings, in which same reference numerals indicate same or similar parts, and in which:

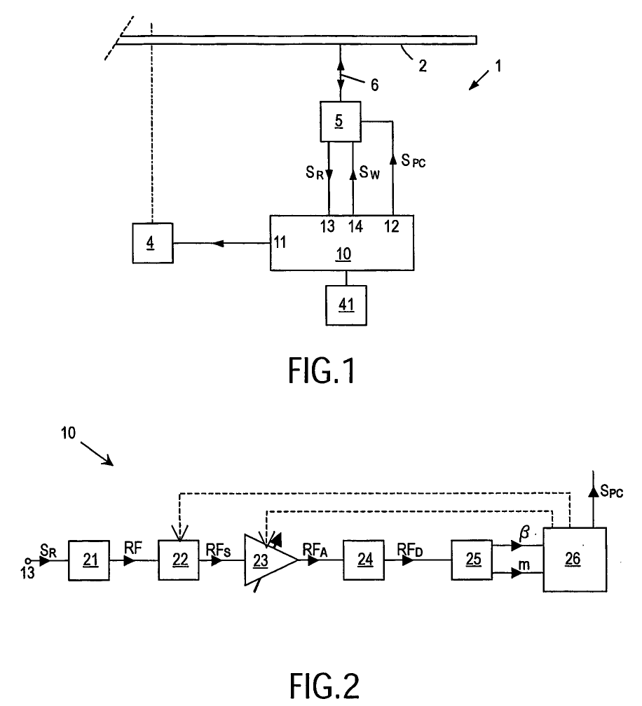

FIG. 1 shows a diagram illustrating some parts of a disc drive apparatus;

FIG. 2 is a block diagram illustrating part of a control circuit in more detail;

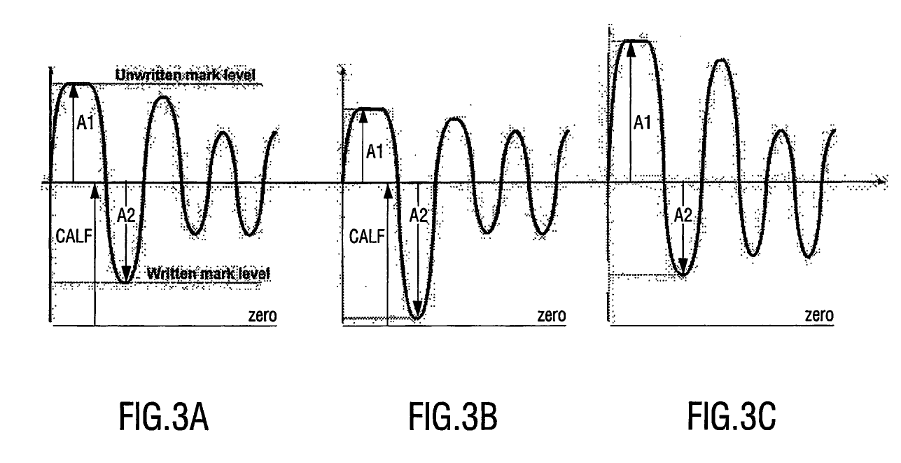

FIGS. 3A-C are graphs illustrating the shape of an optical signal; and

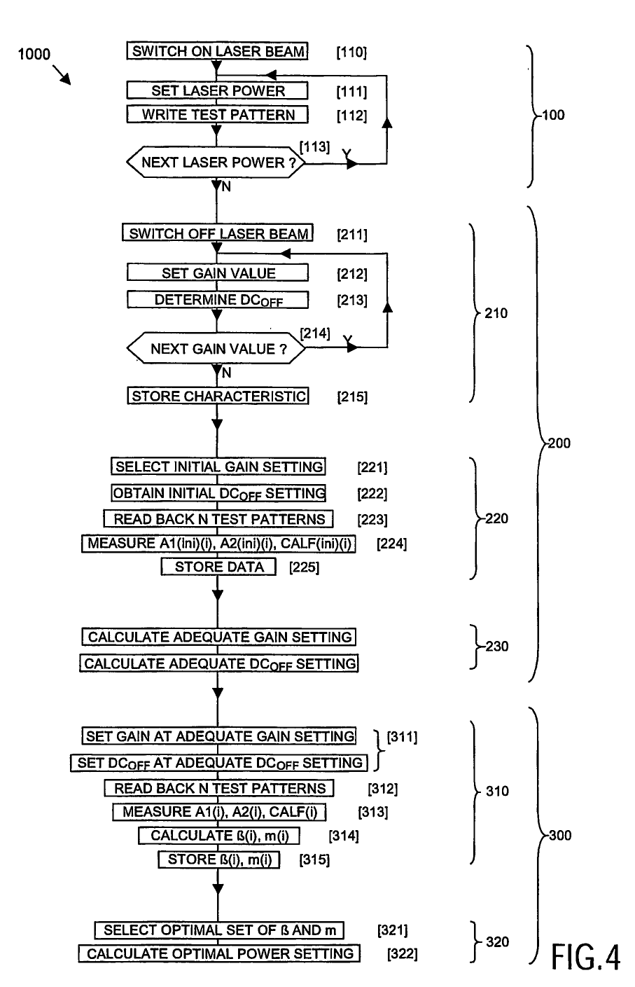

FIG. 4 is a flowchart illustrating an initialization procedure in accordance with the present invention.

FIG. 1 schematically illustrates some parts of an optical disc drive apparatus 1 capable of writing information to a recordable disc 2. For example, the disc 2 is an optical (including magneto-optical) disc, such as a CD, a DVD, etc. The disc drive 1 comprises a motor 4 for rotating the disc 2, and an optical pickup unit 5 for focusing a laser beam 6 on the information layer and for scanning the tracks (not shown) of the disc 2 with this laser beam. The optical pickup unit 5 comprises a laser source and optical components like lenses prisms, etc, as is commonly known and not shown for the sake of simplicity.

The disc drive 1 further comprises a control circuit 10 having a first output 11 for controlling the motor 4 and having a second output 12 for controlling the optical pickup unit 5. The control circuit 10 further has a data input port 13 and a data output port 14. In a reading mode, the data input port 13 receives a data read signal S_{R} from the optical pickup unit 5. In a writing mode, the control circuit 10 provides a data write signal S_{W} at its data output port 14.

FIG. 2 is a block diagram illustrating part of the control circuit 10 in more detail. The control circuit 10 comprises a read signal processing circuit 21 which receives the optical read signal S_{R} as received at control circuit input 13 from an optical detector (not shown) in the optical pickup unit 5 and which provides an output signal RF representing the data contents of the optical read signal S_{R}.

This signal is received by a controllable DC controller 22 which performs a DC offset by shifting the DC level of signal RF to a suitable value. The DC-shifted signal RF_{S} is received by an amplifier 23 having a variable and controllable gain that suitably amplifies the DC-shifted signal RF_{S} to provide an amplified signal RF_{A}, which is supplied to an input of an AD converter 24. The output signal RF_{D} of the AD converter 24 is a digital representation of the shifted and amplified optical signal RF. Thus, the further signal processing takes place in the digital domain.

FIGS. 3A-C contain graphs illustrating the shape of the RF signal readout from a disc. In these Figures, the vertical axis represents signal amplitude, the horizontal axis represents time. The readout signal is characterized by an average level or low-frequency component CALF and, with respect to this average signal level CALF, a positive amplitude A1 and a negative amplitude A2. As is the convention in optical storage, the positive amplitude A1 corresponds to an unwritten mark (high reflective area on the disc), while the negative amplitude A2 corresponds to a written mark (low reflective area on the disc).

A parameter β is defined according to the following formula (1a):

$$β = \frac{A1 + A2}{A1 - A2} \qquad ( 1 a )$$

with A1>0 and A2<0.

A parameter m is defined according to the following formula (1b):

$$m = \frac{A1 - A2}{A1 + CALF} \qquad ( 1 b )$$

with A1>0, A2<0, and CALF>0.

FIG. 3A illustrates the shape of the optical signal RF in normal circumstances. FIG. 3B illustrates the shape of the optical signal RF for a case where the data have been recorded with too low a laser power. FIG. 3C illustrates the shape of the optical signal RF for a case where the data have been recorded with too high a laser power. These cases can be distinguished by said parameters β and m, and on the basis of these parameters it is possible for the control circuit 10 to calculate an optimum laser power.

The digital signal RFD is received by a calculating block 25 that is adapted to calculate said parameters β and m. Although these parameters may be calculated in the analog domain, it is a specific feature of the present invention that they are calculated digitally.

The parameters β and m calculated by the digital calculating block 25 are received by a processor 26 which is designed to calculate a suitable power control signal S_{PC} for the laser source of the optical pickup 5. Since calculating a suitable power control signal S_{PC} for the laser source on the basis of the parameters β and m is known per se, it is not necessary here to explain such a calculation in more detail. The variable parameters with which the DC control block 22 and the variable gain amplifier 23 operate can be set under the control of the processor 26.

An important factor here is that the parameters β and m should be calculated fast and accurately from the digital signal RF_{D} samples provided by the ADC 24. More specifically, for a good measurement of β, accurate measurements of the amplitudes A1 and A2 are needed; for a good measurement of m, accurate measurements of the amplitudes A1 and A2 as well as the DC level CALF are needed. Normally, an 8-bit A/D converter provides this accuracy, but such converters are relatively slow and are large, and therefore relatively expensive, in terms of silicon surface area. However, in current optical drives it is necessary to sample the RF signal at very high speeds, for which reason it is necessary to use faster A/D converters at the expense of a lower quantization accuracy. Therefore, in order to be able to use a 6-bit A/D converter as the ADC 24, it is desirable that the measuring range of the ADC 24 corresponds substantially to the minimum signal level CALF+A2 (with A2<0) and the maximum signal level CALF+A1 (with A1>0). In other words, the maximum output value 111111 should substantially correspond to the maximum signal level CALF+A1 while the minimum output value 000000 should substantially correspond to the minimum signal level CALF+A2. Therefore, an optimum setting of the DC controller 22 and the variable gain amplifier 23 is required.

A problem in this respect is that during an initialization procedure of the disc drive test recordings are made at different laser power settings, which are subsequently read back, and the parameters β and m are to be calculated for all these test recordings. Subsequently, it is decided which test recording corresponds to the optimum values of the parameters β and m, and hence to the optimum laser power setting. In such test runs at different laser power settings, the values of CALF+A1 and CALF+A2 change. Therefore, a setting of the DC controller 22 and of the variable gain amplifier 23 is required which is capable of accommodating such test runs 2. The present invention proposes a calibration algorithm that solves this problem.

Next with reference to FIG. 4, an initialization procedure 1000 in accordance with the present invention will be explained. In a test pattern writing procedure 100, a sequence of N (N being an integer larger than 1) test patterns is written to disc. In a scaling procedure 200, adequate settings of the gain G of the VGA 23 and of the DC offset DC_{OFF} of the DC controller 22 are determined. Subsequently, in a power setting calculation procedure 300, an optimum power setting P_{OPT} for the optical pickup 5 is calculated on the basis of said sequence of N test patterns using said adequate settings of the gain G and of the DC offset DC_{OFF}.

In the test pattern writing procedure 100 the laser beam is switched on [step 110], the laser power is set to a first power setting [step 111], and a test pattern is written [step 112]. This step is repeated for several different settings of the laser power, usually a series of increasing laser powers [step 113].

In the scaling procedure 200, first an electrical DC offset characteristic determination procedure 210 is performed wherein the contribution to the DC offset is determined. The laser beam is switched off [step 211], and the VGA 23 is set to a first gain value [step 212]. In this situation the signal level of the signal RF should be substantially zero; any non-zero output value of ADC 24 is due to electrical offset. A DC offset compensating control signal DC_{OFF} for the DC controller 22 is determined, such that the electrical offset is compensated [step 213].

Unfortunately for practical implementations of analog circuits, the electrical offset usually depends on the gain G of the VGA 23. Therefore, the above is repeated at different settings of the gain value and the corresponding compensating control signals for the DC controller 22 are determined [step 214]. As a result, a series of gain values G and corresponding DC offset values DC_{OFF} is obtained, which series constitutes the electrical DC offset characteristic of the control circuit 10. This characteristic is stored, for example in a table [step 215]. It is to be noted that this electrical DC offset characteristic determination procedure 210 may be performed in advance, that is, before the test pattern writing procedure 100.

Net, an initial read-back procedure 220 is performed. The gain G of the VGA 23 is set at a first, initial setting G(ini) [step 221] which may be chosen as desired, and which normally will not be the optimum setting because this optimum setting is not known yet From the above-mentioned characteristic the corresponding setting for the DC offset value DC_{OFF}(ini) of the DC controller 22 is derived [step 222]. With these initial settings, the sequence of N test recordings is read back [step 223]. In this reading, the signal levels A1(ini), A2(ini), and CALF(ini) are measured for each of said N test recordings [step 224]. Thus a series is obtained of N combinations of A1(ini)(i)>0, A2(ini)(i)<0, and CALF(ini)(i)>0,

where i=1, 2, 3, . . . N. This series is stored, for example in a table [step 225].

Next, a setting selection procedure 230 for selecting adequate settings of the gain G of the VGA 23 and the DC offset value DC_{OFF} of the DC controller 22 is performed on the basis of the series of N combinations of data obtained in the initial read-back procedure 220. Here, several possibilities are available. In a first possibility, the DC offset is calculated such that the average of all CALF(i) corresponds substantially to the center of the measuring range of the ADC 24. The setting of the gain G of the VGA 23 is the gain setting corresponding to this offset in said characteristic table. In a second possibility, the DC offset is calculated such that the center between the lowest value of A2(i) (indicated as MIN(A2)) and the highest value of A1(i) (indicated as MAX(A1)) corresponds substantially to the center of the measuring range of the ADC 24; in other words, {MN(A2)+MAX(A1)}/2 corresponds substantially to the center of the measuring range of the ADC 24. The setting of the gain G of the VGA 23 is the gain setting corresponding to this offset in said characteristic table. In a third possibility, which is a variation of the first possibility, the setting of the gain G of the VGA 23 is such that MN(A2) corresponds substantially to the lower limit of the measuring range of the ADC 24, or MAX(A1) corresponds substantially to the upper limit of the measuring range of the ADC 24. In a fourth possibility, which is a variation of the second possibility, the setting of the gain G of the VGA 23 is such that MIN(A2) corresponds substantially to the lower limit of the measuring range of the ADC 24 and MAX(A1) corresponds substantially to the upper limit of the measuring range of the ADC 24.

Next, a second read-back procedure 310 is performed. The gain G of the VGA 23 and the DC offset value DC_{OFF} of the DC controller 22 are set at the adequate values selected in the setting selection procedure 230 [step 311]. With these secondary settings, said sequence of N test recordings is again read back [step 312]. In this reading, the signal levels A1, A2, and CALF are again measured for each of said N test recordings [step 313]. Thus a secondary series is obtained of N combinations of A1(i)>0, A2(i)<0, and CALF(i)>0, where i=1, 2, 3, . . . N. For each combination, the corresponding values of parameters β(i) and m(i) are calculated [step 314]. These values are stored, for example in a table [step 315].

Finally, a power setting calculation procedure 320 is performed. From the N sets of parameter values β(i) and m(i) obtained in the second read-back procedure 310 an optimum set of parameters β(i) and m(i) is selected [step 321], and the corresponding laser power is selected as the optimum power setting and used in subsequent recording operations [step 322].

Alternatively, the setting selection procedure 230 and second read-back procedure 310 may be repeated once more if a further refinement is required.

It should be clear to those skilled in the art that the present invention is not limited to the exemplary embodiments discussed above, but that several variations and modifications are possible within the protective scope of the invention as defined in the appended claims. In the above, the present invention has been explained with reference to block diagrams, which illustrate functional blocks of the device according to the present invention. It is to be understood that one or more of these functional blocks may be implemented in hardware, where the function of such a functional block is performed by individual hardware components, but it is also possible that one or more of these functional blocks are implemented in software, so that the function of such a functional block is performed by one or more program lines of a computer program or a programmable device such as a microprocessor, microcontroller, etc.

1. Optical disc drive apparatus (1) capable of writing information to a recordable optical disc (2), comprising:
an optical pickup unit (5) arranged for generating a laser beam (6);
a control circuit (10) having a data input port (13) coupled to receive a data read signal (SR) from the optical pickup unit (5), having a data output port (14) for providing a data write signal (S_{W}) to the optical pickup unit (5), and having a control output (12) for controlling the optical pickup unit (5),
wherein the control circuit (10) comprises:
a read signal processing circuit (21) adapted to receive the analog data read signal (S_{R}) from the optical pickup unit (5) and to provide an analog data signal (RF);
a controllable DC controller (22) adapted to provide a DC offset to the analog data signal (RF) from the read signal processing circuit (21);
a variable gain amplifier (23) adapted to receive the DC-shifted signal (RF_{S}) from the DC controller (22), and to amplify this signal with a certain gain factor,
an AD-converter (24) adapted to receive the amplified analog signal (RF_{A}) from the amplifier (23), and to provide a digital output signal (RF_{D});
a digital calculating block (25) adapted to receive the digital output signal (RF_{D}) from the AD-converter (24), and to digitally calculate at least one parameter (β, m) indicative of write operation quality; and
a processor (26) adapted to receive said at least one quality indicating parameter (β, m) provided by the digital calculating block (25), and to calculate a suitable power setting for the laser source of the optical pickup (5) on the basis of said at least one quality indicating parameter (β, m).

2. Apparatus according to claim 1, said processor (26) being adapted to generate control signals for said controllable DC controller (22) and said variable gain amplifier (23).

3. Apparatus according to claim 1, said digital calculating block (25) being adapted to calculate two quality indicating parameters β and m in accordance with the following formulas:
$$β = \frac{A1 + A2}{A1 - A2}$$
$$m = \frac{A1 - A2}{A1 + CALF}$$
where A1>0, A2<0, and CALF>0,
wherein CALF represents the DC level of the amplified analog signal (RF_{A}) from the amplifier (23);
wherein A1 represents a positive amplitude of the amplified analog signal (RF_{A}) corresponding to an unwritten mark; and
wherein A2 represents a negative amplitude of the amplified analog signal (RF_{A}) corresponding to a written mark.

4. Apparatus according to claim 1, wherein the control circuit (10) is adapted to perform, in an initialization procedure (1000),
a test pattern writing procedure (100), wherein a series of N test recordings at different laser power settings are made;
a scaling procedure (200), wherein adequate settings of the gain (G) of the VGA (23) and of the DC offset (DC_{OFF}) of the DC controller (22) are determined; and
a power setting calculation procedure (300), wherein an optimum power setting (P_{OPT}) for the optical pickup (5) is calculated.

5. Apparatus according to claim 4, wherein the scaling procedure (200) comprises the steps of:
performing an electrical DC offset characteristic determination procedure (210), wherein a setting of the DC controller (22) for eliminating the electrical contribution to the DC offset is determined;
performing an initial read-back procedure (220) with an initial setting of the DC controller (22) and of the VGA (23);
performing a setting selection procedure (230) for selecting adequate settings of the gain (G) of the VGA (23) and the DC offset value (DC_{OFF}) of the DC controller (22) on the basis of the data obtained in the initial read-back procedure (220);
and wherein the power setting calculation procedure (300) comprises the steps of:
performing a second read-back procedure (310) in which the gain (G) of the VGA (23) and the DC offset value (DC_{OFF}) of the DC controller (22) are set to the adequate values selected in the setting selection procedure (230);
calculating a power setting for the optical pickup (5) on the basis of the data obtained in the second read-back procedure (310).

6. Apparatus according to claim 5, wherein the electrical DC offset characteristic determination procedure (210) comprises the steps of:
switching off the laser beam [step 211];
setting the VGA (23) to a first gain value [step 212];
determining a DC offset compensating control signal (DC_{OFF}) for the DC controller (22) such that the electrical offset is compensated [step 213];
repeating steps 211-213 at different settings of the gain value and obtaining a series of gain values (G) and corresponding DC offset values (DC_{OFF}).

7. Apparatus according to claim 6, wherein the initial read-back procedure (220) comprises the steps of:
setting the gain (G) of the VGA (23) to a first, initial setting G(ini) [step 221];
deriving the corresponding setting for the DC offset value DC_{OFF}(ini) of the DC controller 22 [step 222];
reading back the sequence of N test recordings [step 223];
measuring the signal levels A1(ini), A2(ini) and CALF(ini) for each of said N test recordings [step 224].

8. Apparatus according to claim 7, wherein the setting selection procedure (230) comprises the steps of:
calculating the DC offset such that the average of all CALF(i) values corresponds substantially to the center of the measuring range of the ADC (24);
selecting the gain setting corresponding to this offset as obtained in said electrical DC offset characteristic determination procedure (210).

9. Apparatus according to claim 7, wherein the setting selection procedure (230) comprises the steps of:
calculating the DC offset such that the center between the lowest value of A2(i) and the highest value of A1(i) corresponds substantially to the center of the measuring range of the ADC (24);
selecting the gain setting corresponding to this offset as obtained in said electrical DC offset characteristic determination procedure (210).

10. Apparatus according to claim 7, wherein the setting selection procedure (230) comprises the steps of:
calculating the DC offset such that the average of all CALF(i) values corresponds substantially to the center of the measuring range of the ADC (24);
selecting the gain setting such that the lowest value of A2(i) corresponds substantially to the lower limit of the measuring range of the ADC (24), or such that the highest value of A1(i) corresponds substantially to the upper limit of the measuring range of the ADC (24).

11. Apparatus according to claim 7, wherein the setting selection procedure (230) comprises the steps of:
calculating the DC offset such that the center between the lowest value of A2(i) and the highest value of A1(i) corresponds substantially to the center of the measuring range of the ADC (24);
selecting the gain setting such that the lowest value of A2(i) corresponds substantially to the lower limit of the measuring range of the ADC (24) and such that the highest value of A1(i) corresponds substantially to the upper limit of the measuring range of the ADC (24).

12. Apparatus according to claim 5, wherein the second read-back procedure (310) comprises the steps of:
setting the gain (G) of the VGA (23) and the DC offset value (DC_{OFF}) of the DC controller (22) to the adequate values selected in the setting selection procedure (230) [step 311];
reading back again said sequence of N test recordings [step 312];
measuring the signal levels A1, A2 and CALF for each of said N test recordings [step 313] so as to obtain a series of N combinations of A1(i), A2(i), and CALF(i), with i=1, 2, 3, . . . N;
for each combination calculating the corresponding values of parameters β(i) and m(i) [step 314].

13. Apparatus according to claim 5, wherein the setting selection procedure (230) and the second read-back procedure (310) are further repeated at least once more.

14. Apparatus according to claim 12, wherein the power setting calculation procedure (320) comprises the steps of:
selecting an optimum set of parameters β(i) and m(i) from the N sets of parameter values β(i) and m(i) as obtained in the second read-back procedure (310) [step 321];
calculating an optimum power setting for the optical pickup (5) on the basis of the optimum set of parameters β(i) and m(i) selected in step 321.

15. Apparatus according to claim 5, wherein the electrical DC offset characteristic determination procedure (210) is performed before the test pattern writing procedure (100).

16. Apparatus according to claim 1, wherein the AD-converter (24) is a 6-bit converter.
